(19) United States
(12) Patent Application Publication
(10) Pub. No.: US 2007/0208769 A1
(43) Pub. Date: Sep. 6, 2007

(54) System and method for generating an XPath expression

(75) Inventors: Christoph Boehm, Berlin (DE); Karen Stone Devlin, Leander, TX (US); Trenten Peterson, Florence, TX (US); Hardeep Singh, Fremont, CA (US)

Correspondence Address: SAWYER LAW GROUP LLP, P.O. BOX 51418, PALO ALTO, CA, 94303, US

(73) Assignee: International Business Machines Corporation

(21) Appl. No.: 11/368,292

(22) Filed: Mar. 3, 2006

(51) Int. Cl. G06F 17/00

(52) U.S. Cl. 707/102

(57) ABSTRACT

An XPath generation system generates a default XPath expression (XPath) from a selected destination node. The system provides to a user the default XPath with modification options. The system modifies the default XPath according to selected modification options to generate a resulting XPath. If none of the modifications options are selected, the system selects the default XPath as the resulting XPath. The modification options comprise selecting a different node as a destination node of the XPath, selecting a context node as a starting node of the XPath, selecting an axis for specifying a path between the context node and the destination node, specifying selection of a node by name or by type, specifying selection of any node, and specifying return of only unique values of the resulting XPath.

### CROSS-REFERENCE TO RELATED APPLICATIONS

The present application relates to co-pending U.S. patent application, titled “System and Method for Building a Unified Query that Spans Heterogeneous Environments,” Ser. No. ______, which is filed concurrently herewith, and to co-pending U.S. patent application, titled “Query Builder Using Context Sensitive Grids,” Ser. No. 10/985,431, filed on Nov. 10, 2004, both of which applications are assigned to the same assignee as the present application.

### FIELD OF THE INVENTION

The present invention generally relates to querying an XML source comprising data stored in XML schemas and in particular an interactive, graphical method of generating an XPath expression for a query of the XML source.

### BACKGROUND OF THE INVENTION

Data is increasingly being stored in databases in structured or semi-structured form using XML schemas. Storing data in a database requires retrieval of desired data in response to a query. One method for querying for data in such a database uses a query language for XML, XQuery.

In the context of creating an XQuery over XML sources, a query developer may create an XPath expression (interchangeably referenced herein as an XPath) to locate or select a node and create a node sequence. An application development tool such as an XPath builder is typically provided to help the developer write the XPath expression. Although this technology has proven to be useful, it would be desirable to present additional improvements.

Conventional XPath builders can be complicated, requiring the developer to determine one or more “path steps” in an XPath that direct the XPath builder from a “context node” or “starting node” to a “selected node” or “destination node”. Consequently, the developer is required to make choices that are of little consequence to the resulting XPath expression involving how to navigate a selected XML structure from the context node to the selected node.

Other conventional XPath building tools are simplistic, only requiring the developer to select a desired context node from a graphical representation of an XML document from which an Xpath is generated. These simplistic XPath building tools typically do not allow the developer to choose a context for the XPath other than, for example, a “root node” of the XML document or a context predetermined by the XPath building tool. In the context of creating an XQuery, the XPath building tool cannot always know the desired context. Consequently, the developer needs an option to change from the default context node to other valid context nodes.

Further, the XML document used by these conventional XPath building tools is typically only representative of the type of document that are queried. Other documents of the same type can have slightly differing structures; however, the conventional XPath building tools do not allow the developer flexibility to generalize the generated path to accommodate these differences in the queried documents.

Moreover, these conventional XPath building tools do not recognize that developers often make approximate choices and then refine these choices over time. Developers often select an initial node from an XML document when what is ultimately desired is a node closely related to the initial node. For example, the developer may select an element when what the developer really wants is the text within that element or the attributes of that element. Consequently, an XPath building tool that does not allow the modification of developer selections may appear cumbersome and awkward to use for the developer.

Furthermore, conventional XPath building tools often do not allow the developer the flexibility to select nodes by kind rather than name. For example, the developer selects an “address” element and the tool creates an XPath pointing to all “address” elements in the selected position. The conventional XPath building tool is unable to provide all elements regardless of name in the same position as the selected element.

Conventional XPath development tools are often too complex for use by a novice developer. Further, conventional XPath development tools are difficult to fit into the context of a larger XQuery building tool. What is needed is an Xpath generating system that simplifies for a developer the task of generating an XPath. An Xpath generating system is also needed that does not require the developer to predetermine all the parameters required to generate the XPath, but rather allows the developer the ability to adapt or modify the XPath as desired.

What is therefore needed is a system, a computer program product, and an associated method for generating an XPath expression. The need for such a solution has heretofore remained unsatisfied.

### SUMMARY OF THE INVENTION

The present invention satisfies this need, and presents a system, a service, a computer program product, and an associated method (collectively referred to herein as “the system” or “the present system”) for generating an XPath expression. The present system generates a default XPath expression from a node in a tree; the node is selected as a destination node of the XPath expression. The present system provides to a user the default XPath expression with a plurality of modification options for modifying the default XPath expression. If at least one of the modification options is selected, the present system modifies the default XPath expression according to the selected modification options to generate a resulting XPath expression. If none of the modifications options are selected, the present system selects the default XPath expression as the resulting XPath expression.

The tree represents an XML schema, an XML document, or a schema or data in any structured or semi-structured language. In one embodiment, the resulting XPath expression is integrated into an XML query.

The modification options comprise any of selecting a different node as a destination node of the XPath expression, selecting a context node as a starting node of the XPath expression, selecting an axis for specifying a path between the context node and the destination node, specifying selection of a node by name, specifying selection of a node by type, specifying selection of any node, and specifying selection of distinct values only, to return only unique values of the resulting XPath expression.

The present system may be embodied in a utility program such as an XPath generation utility program. The present system also provides a method for the user to identify one or more modifications to a default XPath expression by specifying one or more modifications and invoking the XPath generation utility to generate one or more XPath expressions. The modifications comprise selecting a different node as a destination node of the XPath expression, selecting a context node as a starting node of the XPath expression, selecting an axis for specifying a path between the context node and the destination node, specifying selection of a node by name, specifying selection of a node by type, specifying selection of any node, and specifying selection of distinct values only to return only unique values of the resulting XPath expression.

### BRIEF DESCRIPTION OF THE DRAWINGS

The various features of the present invention and the manner of attaining them will be described in greater detail with reference to the following description, claims, and drawings, wherein reference numerals are reused, where appropriate, to indicate a correspondence between the referenced items, and wherein:

FIG. 1 is a schematic illustration of an exemplary operating environment in which an XPath generating system of the present invention can be used;

FIG. 2 is a block diagram of the high-level architecture of the XPath generating system of FIG. 1;

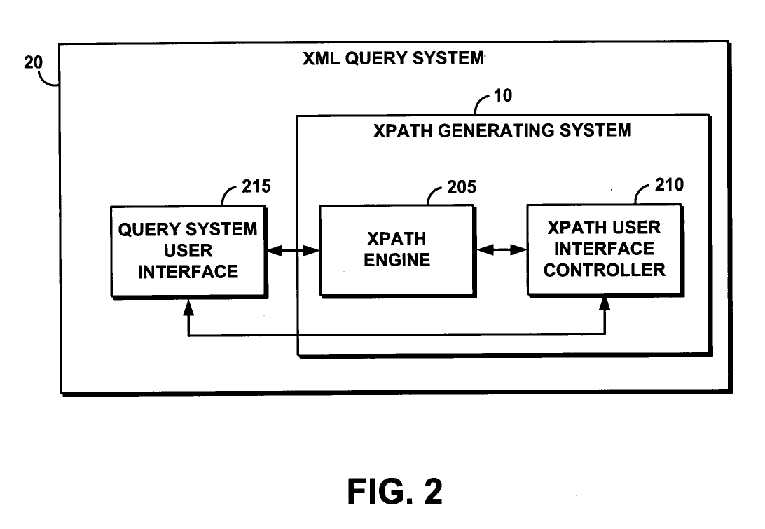

FIG. 3 is an exemplary screen shot of a tree representation of an XML document from which a user can select a node for use by the XPath generating system of FIGS. 1 and 2;

FIG. 4 is an exemplary screen shot of a user interface of the XPath generating system of FIGS. 1 and 2;

FIG. 5 is a process flow chart illustrating a method of operation of the XPath generating system of FIGS. 1 and 2;

FIG. 6 is a process flow chart illustrating a method of operation of the XPath generating system of FIGS. 1 and 2 in generating a default XPath; and

FIG. 7 is a process flow chart illustrating a method of operation of an embodiment of the XPath generating system of FIGS. 1 and 2 in providing input options for the user to generate a default XPath.

### DETAILED DESCRIPTION OF PREFERRED EMBODIMENTS

The following definitions and explanations provide background information pertaining to the technical field of the present invention, and are intended to facilitate the understanding of the present invention without limiting its scope:

FLWOR: an XQuery expression that contains the following clauses: For, Where, Let, Order By, and Return.

XML: extensible Markup Language. A standard format used to describe semi-structured documents and data. During a document authoring stage, XML “tags” are embedded within the informational content of the document. When the XML document is subsequently transmitted between computer systems, the tags are used to parse and interpret the document by the receiving system.

XPath (XML PATH): XPath is a W3C.org defined path language for identity nodes in an XML document. It is a sub-language of XSLT and of XML Query used to identify XML elements for processing, to calculate numbers, and to manipulate strings.

XSL (extensible Stylesheet Language): A standard for describing a style sheet for XML documents. XSL comprises XSL Transformations (XSLT), XML Path Language (XPath), and XSL formatting objects (XSL FO). XSL Transformations (XSLT) is the processing language for XSL. XLST is used to convert XML documents into HTML or other document types and may be used independently of XSL. XML Path Language (XPath) is used to identify and select tagged elements within an XML document. XSL Formatting Objects (XSL FO) provides a format vocabulary.

XQuery (XML QUERY Language): A language for querying XML documents. Based on the XQuery data model, XQuery processes a query by parsing an XML document, a schema for the XML document, and the query into hierarchical node trees. XQuery further generates an output schema with the query results.

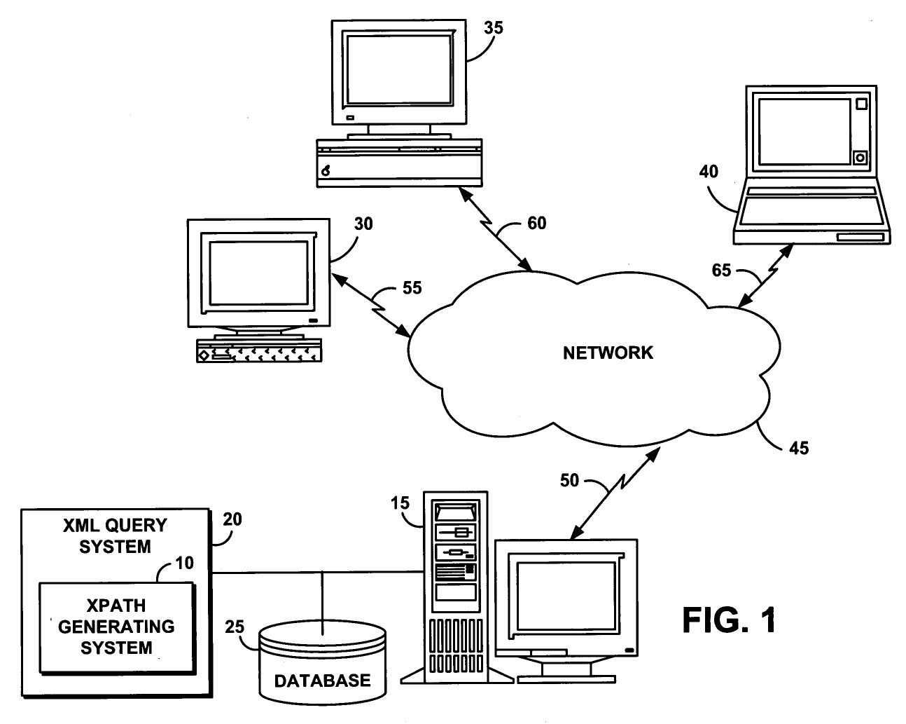

FIG. 1 portrays an exemplary overall environment in which a system, a service, a computer program product, and an associated method (the Xpath generating system 10 or the “system 10”) for generating an Xpath expression (interchangeably referenced herein as an XPath) according to the present invention may be used. System 10 comprises a software programming code or a computer program product that is typically embedded within, or installed on a host server 15. Alternatively, system 10 can be saved on a suitable storage medium such as a diskette, a CD, a hard drive, or like devices. In the exemplary environment of FIG. 1, system 10 is operated in conjunction with an XML query system 20. The XML query system 20 uses an XPath expression generated by system 10 to form a query for data stored in a structured or semi-structured format on a database 25. An exemplary format for the data stored in database 25 is XML.

System 10 can take the form of an entirely hardware embodiment, an entirely software embodiment or an embodiment containing both hardware and software elements. In one embodiment, system 10 is implemented in software, which includes but is not limited to firmware, resident software, microcode, etc.

Furthermore, system 10 can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium comprise a semiconductor or solid-state memory, magnetic tape, a removable computer diskette, a random access memory (RAM), a read-only memory (ROM), a rigid magnetic disk, and an optical disk. Current examples of optical disks include compact disk-read only memory (CD-ROM), compact disk—read/write (CD-R/W) and DVD.

A data processing system suitable for storing or executing program code includes at least one processor coupled directly or indirectly to memory elements through a system bus. The memory elements can include local memory employed during actual execution of the program code, bulk storage, and cache memories that provide temporary storage of at least some program code to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

Developers are represented by a variety of computers such as computers 30, 35, 40, and can access the host server 15 through a network 45. Computers 30, 35, 40 each comprise software that allows the developer to interface securely with the host server 15. The host server 15 is connected to network 45 via a communications link 50 such as a telephone, cable, or satellite link. Computers 30, 35, 40, can be connected to network 45 via communications links 55, 60, 65, respectively: While system 10 is described in terms of network 45, computers 30, 35, 40 may also access system 10 locally rather than remotely. Computers 30, 35, 40 may access system 10 either manually, or automatically through the use of an application.

System 10 enables the developer (interchangeably referenced herein as the user) to generate one or more XPaths in the context of building an XQuery in an XQuery building tool without requiring the developer to make unnecessary decisions. System 10 provides to the developers an XPath that is most likely the desired XPath while providing the flexibility to make changes to the XPath as desired.

System 10 generates a default XPath utilizing a node selected by the developer from a graphical representation of an XML document. The developer may then modify the default XPath by, for example, changing the context node of the XPath, changing the selected node to a close relation of the selected node (i.e., along possible axes), changing the desired position of the selected node in the queried documents, using a descendant axis at any point in the hierarchy above the selected node, changing the node test from a “name test” to a “kind test”, and changing the XPath to return only distinct values of the selected node (i.e., no duplicate values). The developer can apply the modifications to the default XPath in any combination to generate the XPaths as required.

System 10 reduces the complexity required to create an XPath by generating a default XPath, from a default context node to the selected node provided by the developer. System 10 further presents to the developer common, valid options to the default XPath. In one embodiment, system 10 utilizes the XML query system 20 to create predicates. The predicates may be created either in the XPath or in the XQuery as part of the “where” clause of the “FLWOR” expression.

System 10 comprises an XPath engine 205 and an XPath user interface controller 210. The XML query system 20 comprises a query system user interface 215 that interfaces with the XPath engine 205 and the XPath user interface controller 210. The query system user interface 215 enables a user to select a node from an XML document via a graphical user interface. The XML query system 20 further specifies predicates, including predicates that determine the position of the node resulting from the XPath. Position predicates are placed within the XPath on the selected node

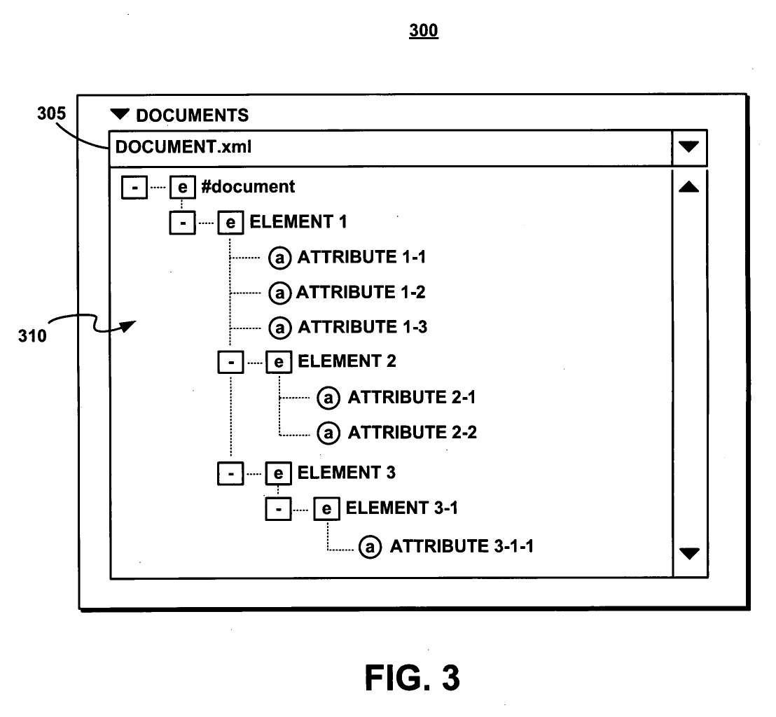

FIG. 3 illustrates an exemplary screen shot 300 of the query system user interface 215 for a tree representation of a document, DOCUMENT.xml 305. Screen shot 300 displays a tree 310 for DOCUMENT.xml 305 in XML form. For example, if the user selects Element2 in the tree, then the default XPath would have the root node, or Element1 as the context. The document node is not the same as the root node. The XPath would appear as “/Element1/Element2”. In another example, assuming the user has previously created an XPath with Element2 as the selected node (as in the previous example), that XPath is being used as the basis for the “For clause” in a FLWOR expression, and the user creates a “Let clause” within the context of the same FLWOR expression by selecting Attribute2-2 from the XML tree 310, then the context of the resulting XPath would be the variable holding the item from the sequence resulting from the XPath created in the previous example. When this XPath is evaluated, the context node would be an Element2, returned as a result of evaluating the XPath the user created in the previous example.

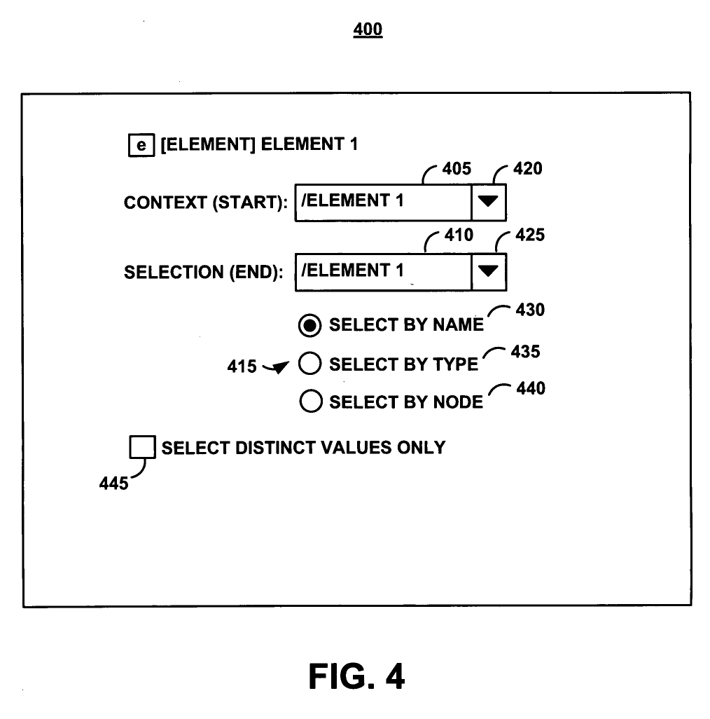

FIG. 4 illustrates an exemplary graphical user interface 400 presented by the XPath user interface controller 210. The graphical user interface 400 comprises a context node box 405 (labeled “Context (start)”) for selecting a context node, a selection node box 410 (labeled “Selection (end)”) for selecting a selection node, and a mutually exclusive option set such as a radio-button group 415. The context node box 405 displays possible valid context nodes and variables representing context nodes. Additional possible valid context nodes and variables are accessed from a pull-down list displayed by selecting a down arrow 420.

The selection node box 410 displays the selected node and related or derived node options. Additional selected node and related or derived node options are accessed from a pull-down list displayed by selecting a down arrow 425. The radio button group 415 enables the user to select options comprising, for example, “select by name” 430, “select by type” 435, or “select any node” 440. The graphical user interface 400 further comprises an option to select distinct values only, presented as a “select distinct values only” check box 445. Selecting the check box 445 puts a distinct values ( ) function around the resulting XPath, to return only unique values of the XPath.

System 10 receives information from the XML query system 15. This received information comprises valid context nodes and variables given, for example, the XQuery within which the XPath is being built. The received information further comprises the node selected by the user from the XML document (the selected node) and an XPath containing some or all of the XPath steps from the root of the XML document to the selected node.

The contents of the selection node box 410 depend upon the selected radio-button option in the radio button group 415. In one embodiment, the option “select by name” 430 is selected by default such that options presented in the selection node box 425 comprise the name of the selected node. The user may select any of the other options in the radio-button group 415. When the user selects one of the other options, the options in the radio-button group 415 changes to reflect the node selection test desired.

As illustration, an exemplary database 25 comprises information for a library in a library database such as, for example, book titles, date the book is ordered, type of book (format), etc. Possible selections (options) for an XPath generated by system 10 are shown in Table 1. These possible selections are based on an XPath structure with “library” as the context node and an element (title) selected as selection node. System 10 displays options for an XPath “/library/books/book/titles/title” in the selection node box 410. These options are displayed when the user selects the down arrow 425.

TABLE 1
Possible selections for an XPath generated by system 10 for an
exemplary library database. These options are available when an element
node is selected: “/library/books/book/titles/title”.

| Option | Select by name | Select by type | Select any node |
|---|---|---|---|
| 1 | /library//title | /library//* | /library//node( ) |
| 2 | books//title | books//* | books//node( ) |
| 3 | book//title | book//* | book//node( ) |
| 4 | titles//title | titles//* | titles//node( ) |
| 5 | title | * | node( ) |
| 6 | title/@* | */@* | node( )/@* |
| 7 | title//@* | *//@* | node( )//@ |
| 8 | title/tex( ) | */text( ) | node( )/text( ) |
| 9 | title//text( ) | *//text( ) | node( )//text( ) |
| 10 | title/* | */* | node( )/* |
| 11 | title//* | *//* | node( )//* |
| 12 | title/parent::* | */parent::* | node( )/parent::* |
| 13 | title/ancestor::* | */ancestor::* | node( )/ancestor::* |
| 14 | title/node( ) | */node( ) | node( )/node( ) |
| 15 | title//node( ) | *//node( ) | node( )//node( ) |
| 16 | title/parent:node( ) | */parent:node( ) | node( )/parent:node( ) |
| 17 | title/ancestor::node( ) | */ancestor::node( ) | node( )/ancestor::node( ) |

Column “select by name” of Table 1 indicates “selected node” options (i.e., options that are presented to the user in the selection node box 410) when “select by name” 430 is selected. Column “select by type” of Table 1 indicates “selected node” options when “select by type” 435 is selected. Column “select any node” of Table 1 indicates “selected node” options when “select any node” 440 is selected. The selection by the user of any of these options is used as part of the information necessary to determine the resulting XPath.

System 10 generates options 1 through 4 in Table 1 from an XPath hierarchy; that the selected node may be found anywhere under each node in the hierarchy (using the descendant-or-self axis). This allows the user to make the resulting XPath flexible to accommodate flexibility in the documents that are queried.

Option 5 shown in bold is the default option, the node selected by the developer from the XML document in the enclosing XQuery building tool.

System 10 derives options 6 through 17 from the selected node, allowing the user to easily modify his original selection to meet his intent. Each node type is represented, and is found along each of the common axes.

Selecting “select by type” 435 allows the developer to select the nodes by their type rather than by their name. As illustrated in Table 1, the type of the selected node is an element. Consequently, available options allow the developer to select an element in the same position as the selected node (or in any position in the hierarchy above the selected node using the descendant-or-self axis) or one of the related nodes (also by type).

Table 1 describes the options available in the selection node box 410 when the user has selected an element node from the XML document to be queried. Options presented in the selection node box 410 are different when the developer has selected a different kind of node. Table 2, Table 3, and Table 4 illustrate the options available for other kind of nodes the developer may select in the XML document. In Table 2, names are not listed in the “select by name” column because text nodes do not have a name. Similarly, in Table 3, names are not listed in the “select by name” column because comment nodes do not have a name. As before, the default option is indicated in bold.

TABLE 2
Options available when an attribute node is selected:
“/library/books/book/titles/title/@orderDate”.

| Option | Select by name | Select by type | Select any node |
|---|---|---|---|
| 1 | /library//@orderDate | /library//@* | /library//node( ) |
| 2 | books//@orderDate | books//@* | books//node( ) |
| 3 | book//@orderDate | book//@* | book//node( ) |
| 4 | titles//@orderDate | titles//@* | titles//node( ) |
| 5 | @orderDate | @* | node( ) |
| 6 | @orderDate/parent::* | @*/parent::* | node( )/parent::* |
| 7 | @orderDate/ancestor::* | @*/ancestor::* | node( )//ancestor::* |
| 8 | @orderDate/ancestor::node( ) | @*/ancestor::node( ) | node( )//ancestor::node( ) |

TABLE 3
Options available when a text node is selected:
““/library/books/book/titles/title/text( )”.

| | Select | | |
|---|---|---|---|
| Option | by name | Select by type | Select any node |
| 1 | | /library//text( ) | /library//node( ) |
| 2 | | books//text( ) | books//node( ) |
| 3 | | book//text( ) | book//node( ) |
| 4 | | titles//text( ) | titles//node( ) |
| 5 | | text( ) | node( ) |
| 6 | | text( )/parent::* | node( )/parent::* |
| 7 | | text( )/ancestor::* | node( )//ancestor::* |
| 8 | | text( )/ancestor::node( ) | node( )//ancestor::node( ) |

TABLE 4
Options available when a comment node is selected:
“/library/books/book/titles/title/comment( )”.

| Option | Select by name | Select by type | Select any node |
|---|---|---|---|
| 1 | | /library//comment( ) | /library//node( ) |
| 2 | | books//comment( ) | books//node( ) |
| 3 | | book//comment( ) | book//node( ) |
| 4 | | titles//comment( ) | titles//node( ) |
| 5 | | comment( ) | node( ) |
| 6 | | comment( )/parent::* | node( )/parent::* |
| 7 | | comment( )/ancestor::* | node( )//ancestor::* |
| 8 | | comment( )/ancestor::node( ) | node( )//ancestor::node( ) |

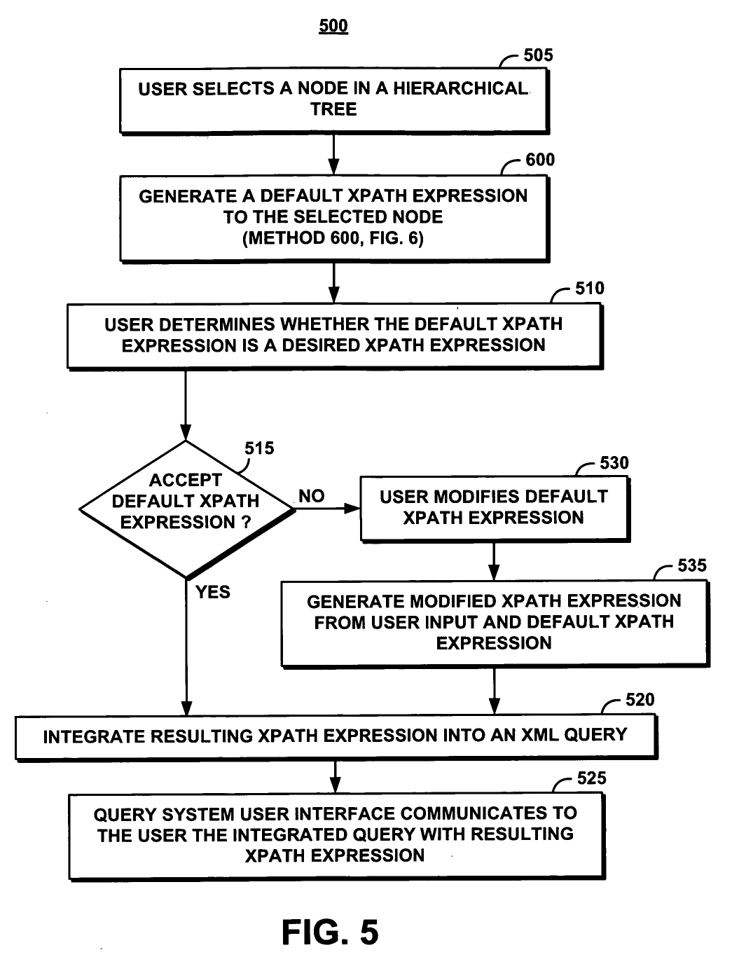

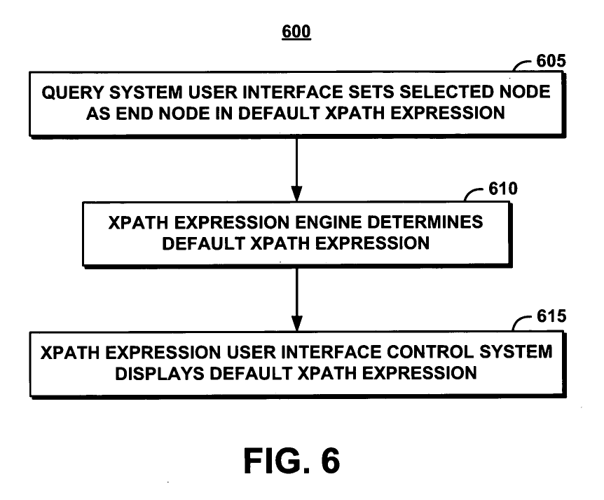

FIG. 5 illustrates a method 500 of system 10 in generating an XPath expression for use by the XML query system 20 to generate an XML query. A user selects a node in a hierarchical tree (step 505). The XPath engine 205 generates a default XPath expression to the selected node (step 600, further illustrated in FIG. 6). The user determines whether the default XPath expression is a desired XPath expression (step 510). If the user accepts the default XPath expression (decision step 515), the default XPath expression is the resulting XPath expression. The XPath engine 205 integrates the resulting XPath expression into an XML query (step 520). The query system user interface 215 communicates to the user the integrated XML query with the resulting XPath expression (step 525).

If the user does not accept the default XPath expression (decision step 515), the user modifies the default XPath expression via user interface controller 210 (step 530). The XPath engine 205 generates a modified XPath expression from user input and the default XPath expression (step 535). The modified XPath expression is the resulting XPath expression. The XPath engine 205 integrates the resulting XPath expression into an XML query (step 520). The query system user interface 215 communicates to the user the integrated XML query with the resulting XPath expression (step 525).

FIG. 6 illustrates a method 600 of system 10 in generating a default XPath expression. Prior to execution of method 600, the user selects a node in the XML tree for use by system 10. The query system user interface 215 sets a selected node as the destination node of a default XPath expression (step 605). The XPath engine 205 determines a default XPath expression corresponding to the selected node (step 610). The XPath user interface controller 210 displays the default XPath expression (step 615).

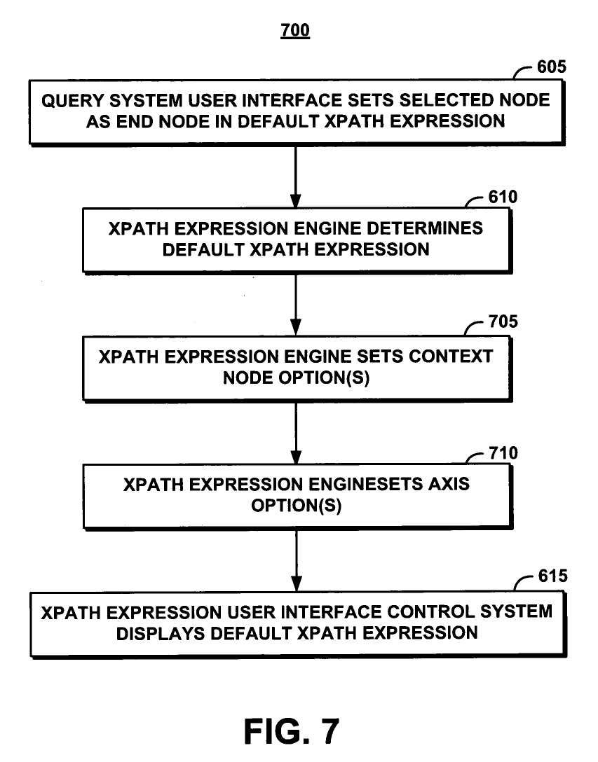

FIG. 7 illustrates a method 700 of an embodiment of system 10 in generating a default XPath expression. Prior to execution of method 700, the user selects a node in the XML tree for use by system 10. The query system user interface 215 sets a selected node as the destination node of an XPath expression as previously described (step 605). The Xpath engine 205 determines a default XPath expression corresponding to the selected node as previously described (step 610). The XPath engine 205 sets one or more context node options (step 705) and sets one or more axis options (step 710). The XPath user interface controller 210 displays the default XPath expression as previously described (step 615). To modify the default XPath expression, the user may select from available context nodes and from available axes. The user may further select a different node test.

It is to be understood that the specific embodiments of the invention that have been described are merely illustrative of certain applications of the principle of the present invention. Numerous modifications may be made to the system and method for generating an XPath expression described herein without departing from the spirit and scope of the present invention. Moreover, while the present invention is described for illustration purpose only in relation to XML, XQuery, and XPath, it should be clear that the invention is applicable as well to, for example, generating a path in any structured or semi-structured data using any path language.

What is claimed is:

1. A processor-implemented method of generating an XPath expression, the method comprising:
generating a default XPath expression from a node in a tree, wherein the node is selected as a destination node of the XPath expression;
providing the default XPath expression with a plurality of modification options for modifying the default XPath expression;
wherein if at least one of the modification options is selected, modifying the default XPath expression according to the selected modification options to generate a resulting XPath expression; and
wherein if none of the modifications options is selected, selecting the default XPath expression as the resulting XPath expression.

2. The method of claim 1, wherein the resulting XPath expression is integrated into an XML query.

3. The method of claim 1, wherein the tree represents an XML schema.

4. The method of claim 1, wherein the tree represents a schema in a semi-structured language.

5. The method of claim 1, further comprising selecting the modification options by selecting a different node as a destination node of the XPath expression.

6. The method of claim 1, further comprising selecting the modification options by selecting a context node as a starting node of the XPath expression.

7. The method of claim 1, further comprising selecting the modification options by selecting an axis for specifying a path between the context node and the destination node.

8. The method of claim 1, further comprising selecting the modification options by specifying selection of a node by name.

9. The method of claim 1, further comprising selecting the modification options by specifying selection of a node by type.

10. The method of claim 1, further comprising selecting the modification options by specifying a selection of any node, and specifying a selection of distinct values to return unique values of the resulting XPath expression.

11. A computer program product having a plurality of program codes that are stored on a computer-useable medium for generating an XPath expression, the computer program product comprising:
a program code for generating a default XPath expression from a node in a tree, wherein the node is selected as a destination node of the XPath expression;
a program code for providing the default XPath expression with a plurality of modification options for modifying the default XPath expression;
wherein if at least one of the modification options is selected, a program code modifies the default XPath expression according to the selected modification options to generate a resulting XPath expression; and
wherein if none of the modifications options is selected, a program code selects the default XPath expression as the resulting XPath expression.

12. The computer program product of claim 11, wherein the resulting XPath expression is integrated into an XML query.

13. The computer program product of claim 11, wherein the tree represents an XML schema.

14. The computer program product of claim 11, wherein the tree represents a schema in a semi-structured language.

15. The computer program product of claim 11, further comprising a program code for selecting the modification options by any one of:
selecting a different node as a destination node of the XPath expression;
selecting a context node as a starting node of the XPath expression;
selecting an axis for specifying a path between the context node and the destination node;
specifying selection of a node by name; and
specifying selection of a node by type.

16. A processor-implemented system having a plurality of program codes that are stored on a computer-useable medium for generating an XPath expression, the system comprising:
an Xpath engine for generating a default XPath expression from a node in a tree, wherein the node is selected as a destination node of the XPath expression;
an XPath user interface controller for providing the default XPath expression with a plurality of modification options for modifying the default XPath expression;
wherein if at least one of the modification options is selected, an XPath engine modifies the default XPath expression according to the selected modification options to generate a resulting XPath expression; and
wherein if none of the modifications options is selected, the XPath engine selects the default XPath expression as the resulting XPath expression.

17. The system of claim 11, wherein the resulting XPath expression is integrated into an XML query.

18. The system of claim 11, wherein the tree represents an XML schema.

19. The system of claim 11, wherein the tree represents a schema in a semi-structured language.

20. The system of claim 11, wherein the XPath user interface controller selects the modification options by any one of:
selecting a different node as a destination node of the XPath expression;
selecting a context node as a starting node of the XPath expression;
selecting an axis for specifying a path between the context node and the destination node;
specifying selection of a node by name; and
specifying selection of a node by type.
